(19) United States
(12) Patent Application Publication
(10) Pub. No.: US 2018/0268228 A1
(43) Pub. Date: Sep. 20, 2018

(54) OBSTACLE DETECTION DEVICE

(71) Applicant: DENSO TEN Limited, Kobe-shi (JP)

(72) Inventors: Katsutoshi OKADA, Kobe-shi (JP); Yuusuke NOMURA, Kobe-shi (JP); Tomohiko IZUTSU, Nagasaki-shi (JP)

(73) Assignee: DENSO TEN Limited, Kobe-shi (JP)

(21) Appl. No.: 15/915,358

(22) Filed: Mar. 8, 2018

(30) Foreign Application Priority Data
Mar. 14, 2017 (JP) 2017-048545

(51) Int. Cl. G06K 9/00; G06T 7/246; G06T 7/269

(52) U.S. Cl. CPC G06K 9/00805; G06T 7/246; G06K 9/00369; G06T 2207/20072; G06T 2207/30196; G06T 2207/30261; G06T 7/269

(57) ABSTRACT

An obstacle detection device includes a detector, a generator, and an estimator. The detector detects a person region where a shape of a person is present, from a captured image. The generator generates an optical flow based on a non-detection image from which the person region is not detected and a detection image from which the person region is detected before the time of the non-detection image in a case where the person region is not detected by the detector. The estimator estimates the person region in the non-detection image based on the optical flow generated by the generator.

### BACKGROUND OF THE INVENTION

### Field of the Invention

The present invention relates to a technology for detecting an obstacle based on an optical flow.

### Description of the Background Art

In the related art, there is an obstacle detection device that detects a person such as a pedestrian as an obstacle from an image captured by an imaging device such as a vehicle-mounted camera. Such an obstacle detection device detects the person based on a dictionary that learned various shapes of the persons and the captured images.

However, in some cases in the obstacle detection device described above, the person may not be detected as the obstacle depending on the shape of the person and a background of the person. Therefore, in the obstacle detection device, it is desirable to improve accuracy of detecting the obstacle.

### SUMMARY OF THE INVENTION

According to an aspect of the present invention, there is provided an obstacle detection device that detects an obstacle. The obstacle detection device includes a controller having a processor and memory. The controller configured to operate as: a detector that detects a person region indicating a shape of a person from a captured image; a generator that generates an optical flow based on (i) a non-detection image from which the person region is not detected and (ii) a detection image from which the person region was detected before a time of the non-detection image, in a case where the person region currently is not detected in the captured image by the detector; and an estimator that estimates the person region in the non-detection image based on the optical flow generated by the generator.

In this way, it is possible to improve the accuracy of detecting the obstacle.

According to another aspect of the present invention, in the obstacle detection device according to the above aspect, the generator sets the person region in the detection image as a target region for generating the optical flow.

In this way, it is possible to reduce the processing load for the generation of the optical flow.

Therefore, an object of the present invention is to provide technologies that can improve the accuracy of detecting the obstacle.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram illustrating an outline of an obstacle detection method.

FIG. 2 is a block diagram illustrating an obstacle detection device.

FIG. 3A is a diagram for explaining processing by a generator (part 1).

FIG. 3B is a diagram for explaining the processing by the generator (part 2).

FIG. 4A is a diagram for explaining processing by an estimator (part 1).

FIG. 4B is a diagram for explaining the processing by the estimator (part 2).

FIG. 4C is a diagram for explaining the processing by the estimator (part 3).

FIG. 5 is a diagram for explaining processing by a calculator.

FIG. 6 is a flowchart illustrating a processing procedure executed by the obstacle detection device.

FIG. 7A is a diagram for explaining a specific example of processing by a generator in a modification example (part 1).

FIG. 7B is a diagram for explaining a specific example of processing by the generator in the modification example (part 2).

### DESCRIPTION OF THE EMBODIMENTS

Hereinafter; an obstacle detection device and an obstacle detection method in an embodiment will be described in detail with reference to the accompanying drawings. The present invention is not limited to the embodiment.

Hereinafter, a case where the obstacle detection device detects a person (hereinafter referred to as a pedestrian H) as an obstacle from the image captured by the vehicle-mounted camera mounted on a host vehicle.

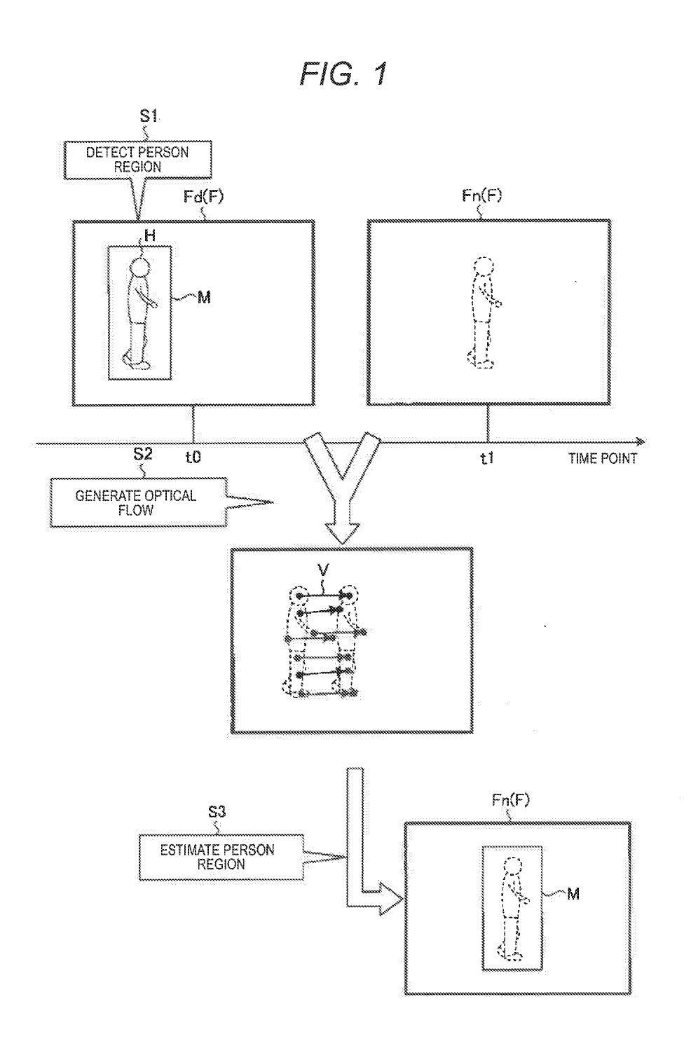

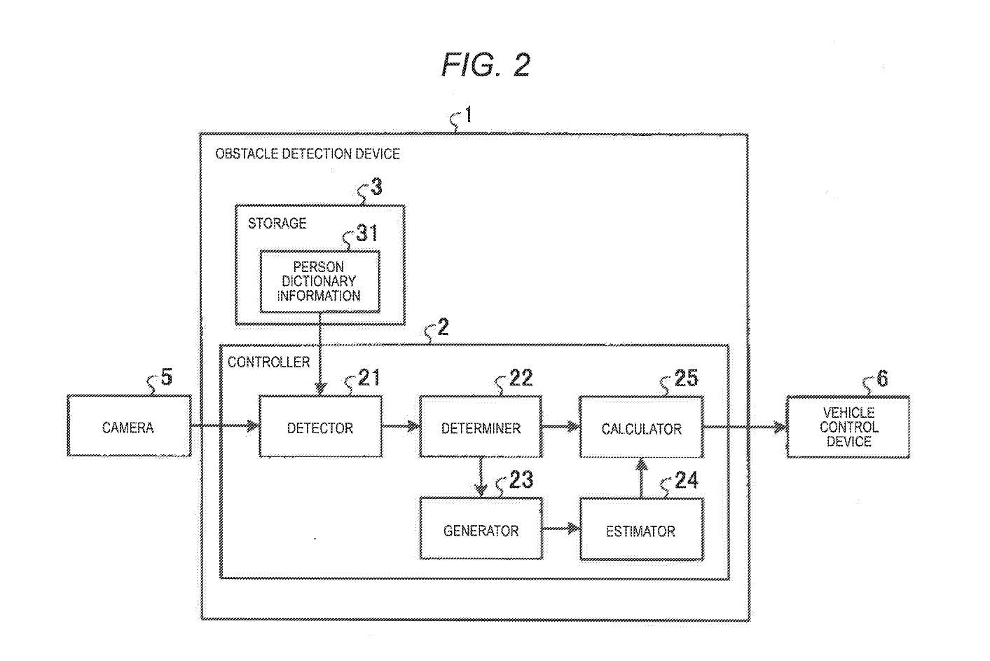

First, an outline of the obstacle detection method in the embodiment will be described with reference to FIG. 1. FIG. 1 is a diagram illustrating the outline of the obstacle detection method. The obstacle detection method is executed by an obstacle detection device 1 which will be described later with reference to FIG. 2.

As illustrated in FIG. 1, in the obstacle detection method in the embodiment, a person region M where a shape of a person is present is detected from a captured image F (STEP S1). For example, in the obstacle detection method, the person region M can be detected from the captured image F using person dictionary information which is a reference for determining whether or not an object projected on the captured image F is the pedestrian H.

In the obstacle detection method in the related art, in a case where the person region M cannot be detected based on the person dictionary information described above, there is a problem in that the pedestrian H is overlooked. For this reason, in the obstacle detection method in the related art, there is a room for improving the accuracy of detecting the obstacle.

Therefore, in the obstacle detection method in the embodiment, in a case where the person region M cannot be detected, it is assumed that the person region M is estimated to be in a non-detection image Fn based on the non-detection image Fn from which the person region M is not detected and a detection image Fd from which the person region M is detected before the time of non-detection image Fn.

Specifically, in the obstacle detection method in the embodiment, in a case where the person region M cannot be detected, an optical flow V is generated from the non-detection image Fn and the detection image Fd (STEP S2). The optical flow V is generated by associating a feature point in the detection image Fd with a feature point in the non-detection image Fn.

In FIG. 1, it is assumed that the captured image F captured at a time point to is the detection image Fd from which the person region M is detected and the captured image F captured at a time point ti is the non-detection image Fn from which the person region M is not detected.

In the obstacle detection method in the embodiment, the person region M in the non-detection image Fn captured at the time point t1 is estimated by estimating the amount of movement of the pedestrian H in a period from the time point t0 to the time point ti based on the optical flow V (STEP S3).

That is, in the obstacle detection method in the embodiment, the person region M is estimated to be in the non-detection image Fn from which the person region M is not detected, based on optical flow V. That is, the undetected person region M is interpolated with the estimated person region M.

In this way, in the obstacle detection method in the embodiment, even in a case where the pedestrian H cannot be detected from the captured image F based on the person dictionary information, a position of the pedestrian H can be estimated based on the optical flow V.

Therefore, according to the obstacle detection method in the embodiment, it is possible to improve the accuracy of detecting the obstacle.

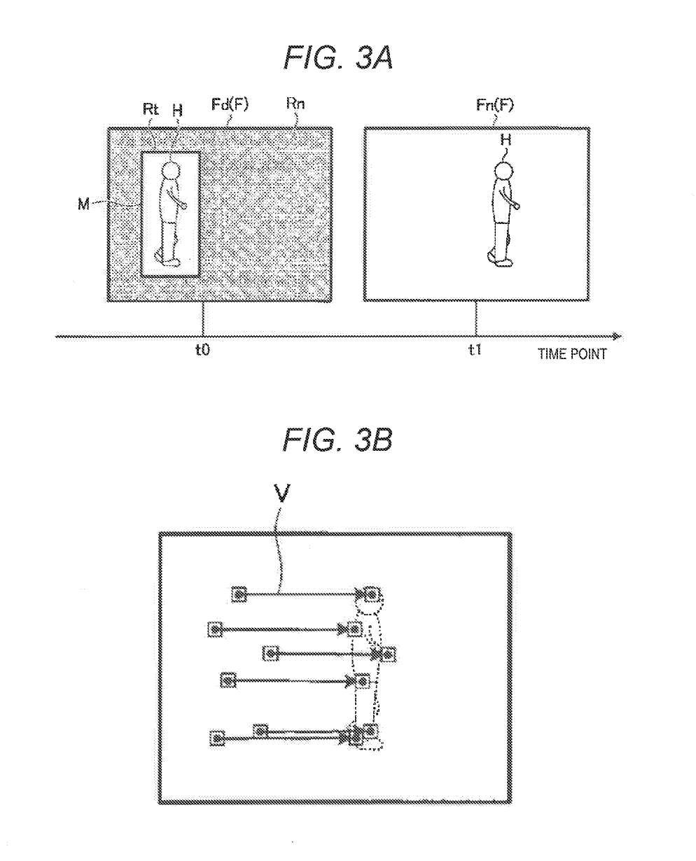

Incidentally, in the obstacle detection method in the embodiment, by limiting a target region for generating the optical flow V in the non-detection image Fn, it is also possible to reduce a processing load for generating the optical flow V. Details of this point will be described later using FIG. 3A.

In addition, in the obstacle detection method in the embodiment, it is also possible to change a scale of the person region M by estimating a distance to the pedestrian H projected in the non-detection image Fn. Details of this point will be described later using FIG. 3C.

Next, a configuration of the obstacle detection device 1 in the embodiment will be described with reference to FIG. 2. FIG. 2 is a block diagram illustrating the Obstacle detection device 1. In. FIG. 2, a camera 5 and a vehicle control device 6 are illustrated as well.

As illustrated in FIG. 2, the obstacle detection device 1 is connected to the camera 5 and the vehicle control device 6. The camera 5 includes imaging elements such as a charge coupled device (CCD) or a complementary metal oxide semiconductor (CMOS), and captures images in front of the host vehicle at a predetermined cycle (for example, a cycle of 1/30 second). The captured image F captured by the camera 5 is sequentially output to the obstacle detection device 1.

The vehicle control device 6 performs vehicle control such as pre-crash safety system (PCS) and advanced emergency braking system (AEB) based on the detection result of obstacle by the obstacle detection device 1.

The obstacle detection device 1 includes a controller 2 and a storage 3. The controller 2 includes a detector 21, a determiner 22, a generator 23, an estimator 24, and a calculator 25. The controller 2 includes, for example, a computer and various circuits having a central processing unit (CPU), read only memory (ROM), random access memory (RAM), a hard disk drive (HDD), and an input output port.

The CPU of the computer functions as the detector 21, the determiner 22, the generator 23, the estimator 24, and the calculator 25 of the controller 2, for example, by reading and executing the program stored in the ROM.

In addition, at least one or all of the detector 21, the determiner 22, the generator 23, the estimator 24, and the calculator 25 of the controller 2 can be configured by hardware such as an application specific integrated circuit (ASIC) or a field programmable gate array (FPGA).

In addition, the storage 3 corresponds to, for example, the RAM and the HDD. The RAM and HDD can store the person dictionary information 31 and various programs.

The obstacle detection device 1 may acquire the program and various kinds of information items via another computer or a portable recording medium connected via a wired or wireless network.

The person dictionary information 31 is information used as a reference for determining whether or not the object projected in the captured image F is the pedestrian H, and is created in advance by machine learning. For example, a predetermined number of images (for example, images of several hundreds to tens of thousands) of plural kinds of persons having well-known shapes and images of objects other than the person are prepared as the learning data.

Subsequently, for example, histograms of oriented gradients (HOG) feature amount are extracted from each prepared image. The prepared image described above is plotted on a two-dimensional plane based on the extracted HOG feature amount.

Subsequently, a separation line for separating the image of a person on the two-dimensional plane and the image of the object other than a person is generated by a discriminator such as a support vector machine (SVM). Information on the coordinate axes of the two-dimensional plane and the separation line generated by the discriminator is the person dictionary information 31.

The feature amount extracted from the prepared image is not limited to the HOG feature amount, and may be a scale invariant feature transform (SIFT) feature amount. In addition, the discriminator used for separating the image of the person and the image of the object other than a person is not limited to SVM, and may be a discriminator such as an AdaBoost.

The detector 21 of the controller 2 detects the person region M in which the shape of the person is present from the captured image F input from the camera 5. For example, the detector 21 detects the person region M using the person dictionary information 31 stored in the storage 3 for each of the captured images F input from the camera 5 at a predetermined cycle. Then, the detector 21 superimposes the detected person region M on the captured image F and outputs the result to the determiner 22.

The determiner 22 determines whether or not the person regions M are continuously detected by the detector 21. Specifically, first, the determiner 22 determines whether or not the person regions M detected by the detector 21 from the temporally continuous captured image F is the person regions M corresponding to the same pedestrian H.

Then, in a case where the person regions M corresponding to the same pedestrian H continue, for example, to be equal to or greater than five consecutive frames, the determiner 22 assigns a person ID to the person region M. In other words, in a case where the person regions M corresponding to the same pedestrian H are not consecutively detected, the person ID is not given to the person region M.

In this way, for example, even in a ease where the detector 21 erroneously detects a noise projected on the captured image F as the person region M, such a person region M can be excluded from a notification target to the vehicle control device 6, in other words, in the obstacle detection device 1, only the information which is based on the highly reliable person region M can be output to the vehicle control device 6.

The captured image F to which the person ID is assigned is the detection image Fd (refer to FIG. 1) described above. The detector 21 outputs person region information that is associated with the information indicating a position and a size of the person region M in the captured image F to which the person ID is assigned, to the calculator 25.

In addition, in a case where the person region M to which the person ID is assigned disappears on the halfway, that is, in a case where the person region M is not continuously detected, the determiner 22 outputs the non-detection image Fn which is the captured image F from which the person region M is not detected and the detection image Fd which comes one frame before the non-detection image Fn, to the generator 23.

Here, “the person region M disappears on the halfway” means a state in which the detector 21 cannot detect the pedestrian H despite that the pedestrian H is projected in the captured image F. In other words, the state means a case where the pedestrian H is departed from the imaging range of camera 5 is not included,

The generator 23 generates the optical flow V from the non-detection image Fn input from the determiner 22 and the detection image Fd. The generator 23 superimposes the generated optical flow V on the non-detection image Fn and outputs the result to the estimator 24. Here, a specific example of the processing by the generator 23 will be described with reference to FIG. 3A and FIG. 3B. FIG. 3A and FIG. 3B are diagrams for explaining processing by the generator 23.

In FIG. 3A, it is assumed that captured image F captured at the time point 10 is the detection image Fd from which the person region M is detected and the captured image F captured at the time point t1 is the non-detection image Fn from which the person region M is not detected.

As illustrated in FIG. 3A, the generator 23 sets the person region M in the detection image Fd as a target region Rt for which the optical flow V is generated, and sets a region other than the target region Rt as the non-target region Rn for which the optical flow V is not generated. In the drawings, the non-target region Rn is hatched to be illustrated.

The generator 23 extracts the edges, that is, the feature amount of the pedestrian H from the target region Rt of the detection image Fd using the Harris method, for example. In other words, the generator 23 sets only the person region M in which the pedestrian H is actually present in the detection image Fd as the target region Rt for edge extraction.

In this way, since the processing load of the generator 23 and the amount of edges extracted from the detection image Fd can be reduced, it is possible to suppress the generation of an erroneous optical flow V when the optical flow V is generated as described later. That is, it is possible to improve the accuracy of generating the optical flow V. The edge extraction method by the generator 23 is not limited to the Harris method, and other edge extraction methods such as a Sobel filter or a Laplacian filter may be used.

Next, as illustrated in FIG. 3B, the generator 23 generates the optical flow V using the block matching method based on the edges extracted from the detection image Fd. For example, the generator 23 scans the detection image Fd with a pixel block (for example, 8×8 pixels) having a center at an edge pixel extracted from the non-detection image Fn as a template image, and then, obtains a difference absolute sum (so-called a sum of absolute difference (SAD)).

The generator 23 generates the optical flow V by connecting the edge of the non-detection image Fn having the minimum SAD and the edge of the detection image Fd. The generator 23 performs the processing described above for each pixel of the edges detected from the detection image Fd.

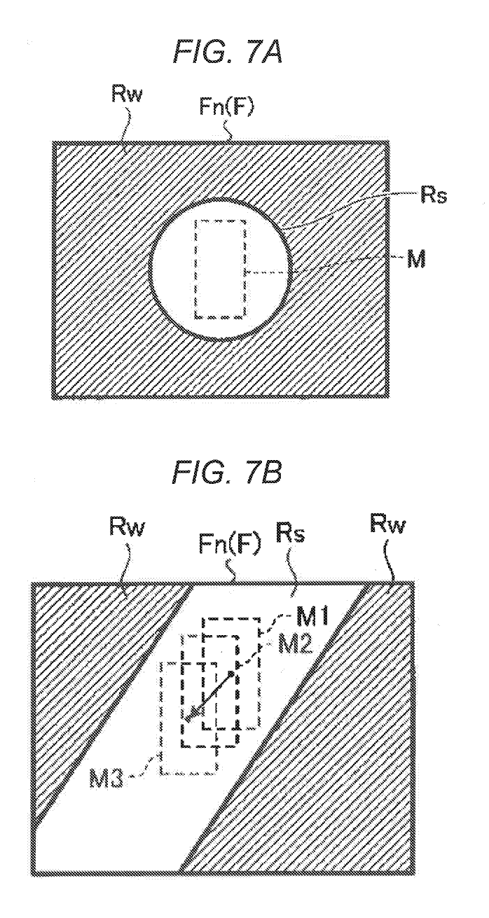

At this time, the generator 23 can also limit a scanning range of the template image in the non-detection image Fn based on, for example, the person region M in the detection image Fd. Details of this point will be described later with reference to FIG. 7A, FIG. 7B and the like.

Instead of the SAD, the generator 23 may generate the optical flow V using another evaluation function such as a sum of squared difference (SSD) or a normalized cross-correlation (NCC). In addition, instead of the block matching method, the generator 23 may generate the optical flow V using another method such as a gradient method,

Returning to the description of FIG. 2, the estimator 24 estimates the person region. M in the non-detection image Fn based on the optical flow V generated by the generator 23. In addition, the estimator 24 generates the person region information in which the person ID same as the person ID assigned by the determiner 22 is assigned to the estimated Person region M, and outputs the generated person region information to the calculator 25.

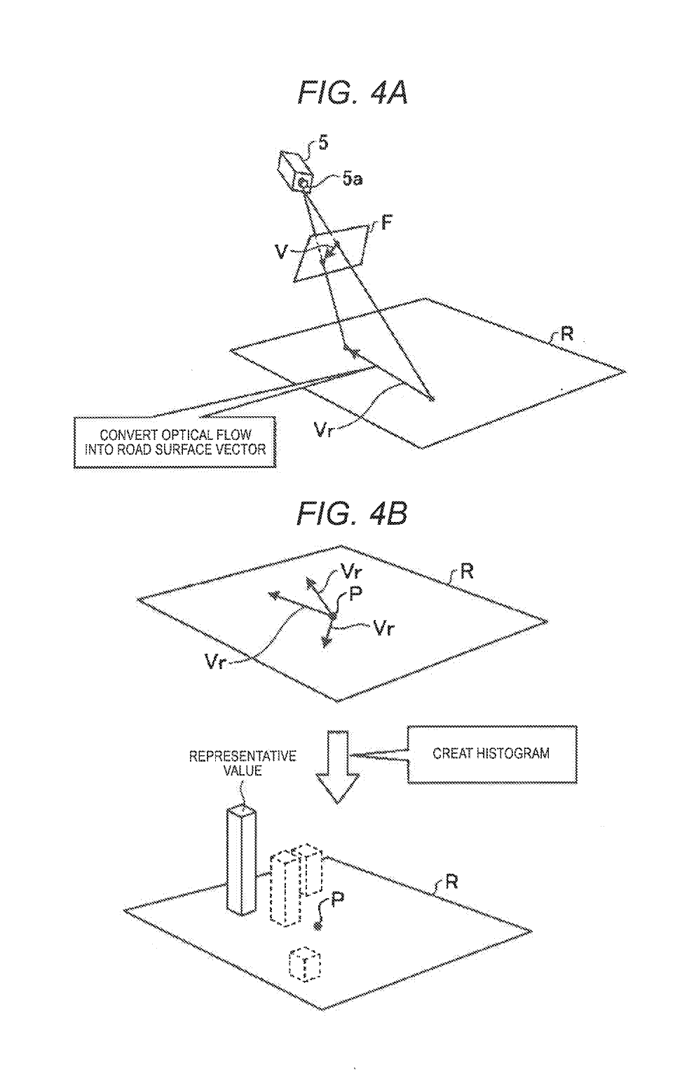

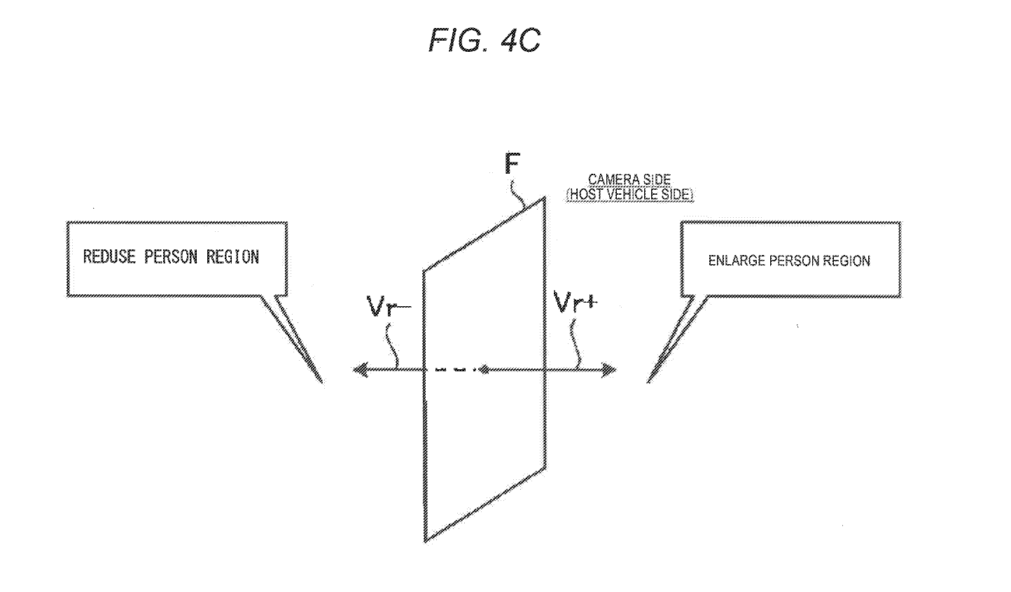

Here, details of the processing by the estimator 24 will be described with reference to FIG. 4A to FIG. 4C. FIG. 4A to FIG. 4C are diagrams for explaining the processing items by the estimator 24. As illustrated in FIG. 4A, the estimator 24 converts the optical flow V into a road surface vector Vr by projecting the optical flow V onto the coordinate plane R based on a viewpoint position 5a of the camera 5.

A size of the road surface vector Vr corresponds to a movement distance of the pedestrian H during a period from the detection image Fd to the capturing of the non-detection image Fn, and the direction of the road surface vector Vr corresponds to the movement direction of the pedestrian H during the period,

Then, the estimator 24 creates a histogram for the size and the direction of the road surface vector Vr and calculates a representative value from the histogram, and then, estimates the movement distance and the movement direction of the pedestrian H based on the representative value.

Specifically, as illustrated in FIG. 4B, the estimator 24 creates a histogram by counting the coordinates of end points of each of the road surface vectors Vr with the initial coordinates of all the road surface vectors Vr as a reference point P. The estimator 24 can obtain a position having the largest number of end points in the histogram as the road surface vector Yr of the representative value.

The estimator 24 can estimate the position of the person region M in the non-detection image Fn by converting the road surface vector Yr of the representative value into the above-described optical flow V again.

Thereafter, the estimator 24 generates the person region information in which the person ID same as the person region M in the detection image Fd is assigned to the estimated person region M, and then, outputs the person region information to the calculator 25. As described above, the estimator 24 can accurately estimate the position of the pedestrian H in the non-detection image Fn by obtaining the representative value based on the histogram.

Here, the case is described, where the estimator 24 creates the histogram from the road surface vector Vr. However, the histogram may be created from the optical flow V and the person region M may be estimated based on the histogram.

Incidentally, the estimator 24 can change the scale of the person region M based on the road surface vector Vr of the representative value. Specifically, for example, as illustrated in FIG. 4C, in a case where the direction of the road surface vector Vr of the representative value is the road surface vector Vr+ direction which is the direction close to the camera 5 side, that is, close to the host vehicle side, the estimator 24 enlarges the person region M in the detection image Fd based on the size of the road surface vector Vr+.

On the other hand, in a case where the direction of the road surface vector Vr of the representative value is a road surface vector Vr− direction which is the direction away from the host vehicle, the estimator 24 can reduce the person region M based on the size of the road surface vector Vr−.

As described above, the estimator 24 can accurately estimate the person region M in the non-detection image Fn not only based on the position of the person region M but also by changing the scale of the person region M. Incidentally, if the processing for estimating the person region M by the estimator 24 is repeated continuously, there is a concern that the position of the actual pedestrian H in the non-detection image Fn and the position of the person region M estimated by the estimator 24 may be diverged.

Therefore, the estimator 24 can limit the number of times of continuously estimating the person region M for the person region M to which the same person ID is assigned. Specifically, for example, the estimator 24 does not continuously perform the estimation processing equal to or more than three frames on the person region M to which the same person ID is assigned.

In this way, the obstacle detection device 1 can avoid the output of low-accuracy information to the vehicle control device 6. Therefore, erroneous control by the vehicle control device 6 based on the low-accuracy information can be suppressed,

Returning to the description in FIG. 2, the calculator 25 of controller 2 will be described. The calculator 25 calculates the distance and direction (hereinafter, referred to as position information) to the pedestrian H with respect to the host vehicle based on the person region information input from the determiner 22 or the estimator 24. In a case where there is a high possibility that the pedestrian H collides with the host vehicle (for example, the distance to the pedestrian H is equal to or shorter than 2 m) based on the calculated position information, the calculator 25 outputs the position information to the vehicle control device 6.

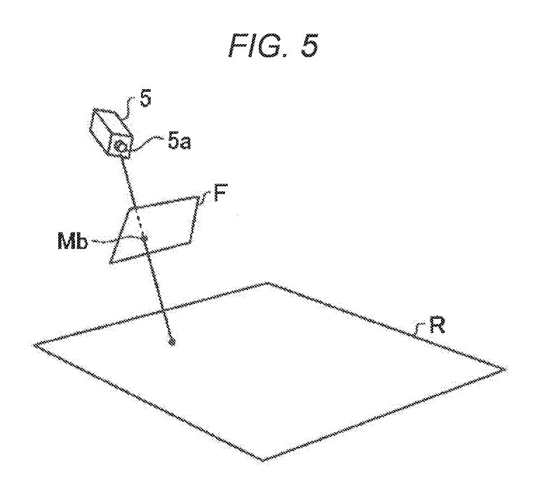

Here, a specific example of the processing by the calculator 25 will be described with reference to FIG. 5. FIG. 5 is a diagram illustrating a specific example of the processing by the calculator 25. The calculator 25 calculates the distance and direction to the pedestrian H using, for example, a lower end Mb of the person region M based on the person region information.

Specifically, as illustrated in FIG. 5, the calculator 25 can calculate the distance and direction to the pedestrian H by projecting the coordinates of the lower end Mb of person region M in the captured image F onto coordinate plane R. Here, the reason for using the lower end Mb is because the lower end Mb is closest to the contact point between the pedestrian H and the road surface.

That is, calculator 25 can accurately calculate the distance and direction to the pedestrian H by calculating the distance and direction to the pedestrian H based on the lower end Mb of person region M.

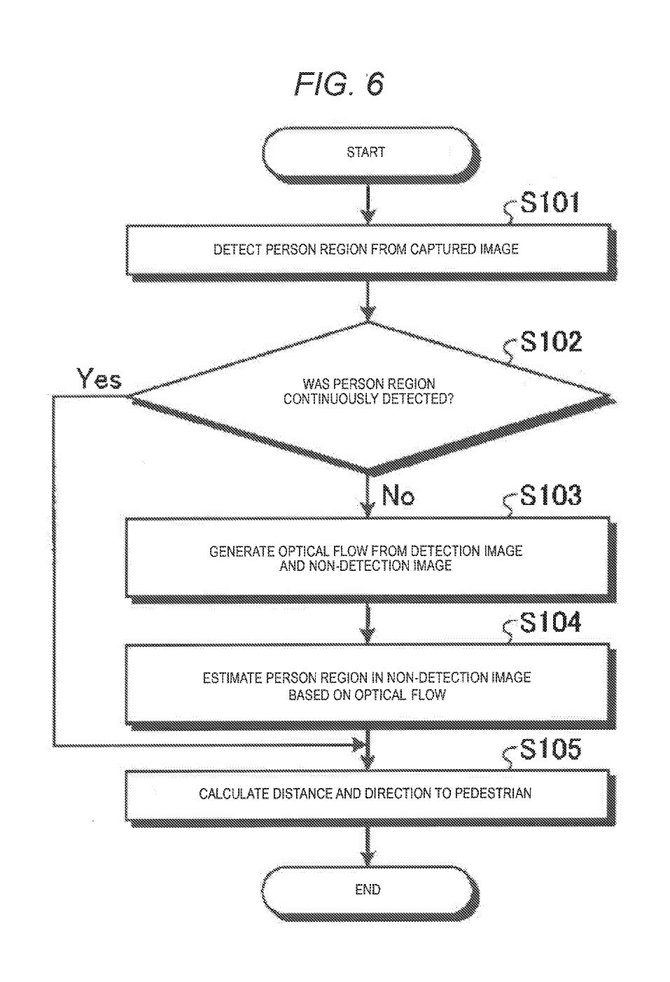

Next, a processing procedure executed by the obstacle detection device 1 in the embodiment will be described with reference to FIG. 6. FIG. 6 is a flowchart illustrating the processing procedure executed by the obstacle detection device 1. The processing procedure is repeatedly executed by the controller 2.

First, the detector 21 of the controller 2 detects the person region M from the captured image F input from the camera 5 (STEP S101). Next, the determiner 22 determines whether or not the person region M is continuously detected (STEP S102). In a case where the person region M is not continuously detected by the determination (No in STEP S102), the generator 23 generates the optical flow V from the detection image Fd and the non-detection image Fn (STEP S103).

Subsequently, the estimator 24 estimates the person region M in the non-detection image Fn based on the optical flow V generated by the generator 23 (STEP S104). The calculator 25 calculates the distance and direction to the pedestrian H (STEP S105) and ends the processing.

On the other hand, in a case where the person region M is continuously detected (Yes in STEP S102), the controller 2 omits the processing in STEP S103 and STEP S104, and performs the processing in STEP S105, and then, ends the processing.

As described above, the obstacle detection device 1 in the embodiment includes the detector 21, the generator 23, and the estimator 24. The detector 21 detects the person region M in which the shape of a person is present, from the captured image F. In a case where the person region M is not detected by the detector 21, the generator 23 generates the optical flow V based on the non-detection image Fn from which the person region M is not detected and the detection image Fd from which the person region M is detected before time of non-detection image Fn.

The estimator 24 estimates the person region M in the non-detection image Fn based on the optical flow V generated by the generator 23. Therefore, according to the obstacle detection device 1 in the embodiment, it is possible to improve the accuracy of detecting the obstacle.

Incidentally, in the embodiment described above, as described in FIG. 3A and FIG. 3B, a case is described, where the generator 23 scans the template image from all the areas of the non-detection image Fn, but the invention is not limited thereto. That is, the generator 23 can limit the scanning range of the template image in the non-detection image Fn. A case where the generator 23 limits the scanning range will be described using FIG. 7A and FIG. 7B.

FIG. 7A and FIG. 7B are diagrams for explaining a specific example of processing by the generator 23 in a modification example. In FIG. 7A and FIG. 7B, the non-detection image Fn is illustrated, and the person region M in the detection image Fd before the time of non-detection image Fn is illustrated by dashed lines.

As illustrated in FIG. 7A, for example, the generator 23 sets a circular shaped range having a center at the person region M in the non-detection image Fn as the scanning range Rs, and sets an area other than the scanning range Rs as a non-scanning range Rw. In FIG. 7A and FIG. 7B, the non-scanning range Rw is hatched to be illustrated.

In this case, the generator 23 scans the template image only in the scanning range Rs as described above. This is because the change amount of the relative distance between the pedestrian H and the host vehicle is limited during the period from the time when the detection image Fd is captured to the time when the non-detection image Fn is captured.

That is, the generator 23 can reduce the processing load while securing the accuracy of estimating the person region M by setting the scanning range Rs in the non-detection image Fn.

For example, the generator 23 may set the scanning range Rs based on a travelling speed and a steering angle of the host vehicle. In addition, here, the case is described, where the scanning range Rs is the circular shape. However, the scanning range Rs may have other shapes such as a polygon.

Next, another example in which the generator 23 limits the scanning range Rs will be described using FIG. 7B. In FIG. 7B, it is assumed that the person regions M are a person region M1 to a person region M3 in an order in the latest detection images Fd.

As illustrated in FIG. 7B, the generator 23 can estimate an area in which the pedestrian H is actually present in the non-detection image Fn based on the person regions M1 to M3 in the plurality of detection images Fd, and can set the estimated region as the scanning range Rs.

In other words, the generator 23 sets an area having a high probability that a pedestrian H is present in the non-detection image Fn as the scanning range Rs, and sets the area having the low probability that the pedestrian H is present as the non-scanning range Rw. In this way, the generator 23 can suppress the processing load while securing the accuracy of generating the optical flow V. The scanning range Rs and the non-scanning range Rw illustrated in FIG. 7B are examples, and are not limited thereto. That is, as long as the scanning range Rs in the non-detection image Fn is set based on the past person region M, the shape, size, and the like can be arbitrarily changed.

Incidentally, in the above-described embodiment, as illustrated in FIG. 3A, the case is described, where the generator 23 sets the target region Rt in the detection image Fd and extracts the edges from the target region Rt, but the invention is not limited thereto.

That is, the generator 23 may extract the edges from all the regions in the detection image Fd and may generate the optical flow V from all the regions in the non-detection image Fn. In this case, the optical flow V based on the pedestrian H has the direction and size different from those of the optical flow V based on an object (for example, a stationary object such as a road surface) other than the pedestrian H. Therefore, the estimator 24 can estimate the optical flow V having the direction and size different from those of the optical flow V corresponding to the stationary object such as the road surface as the optical flow V corresponding to the pedestrian H.

In the embodiment described above, the case is described, where the obstacle detection device 1 detects the pedestrian Has an obstacle. However, the obstacle detection device 1 may detect other vehicles and other objects such as motorcycles as the obstacle. In this case, the person dictionary information 31 illustrated in FIG. 2 may be changed to dictionary information corresponding to the object to be detected.

In the embodiment described above, the case is described, where the optical flow V is generated in a case where the obstacle detection device 1 cannot detect the person region M, but the invention is not limited thereto. That is, the obstacle detection device 1 may generate the optical flow V even in a case where the person region M is detected. In this case, the obstacle detection device 1 can estimate the position of pedestrian H using both the detection result of the person region M and the optical flow V. In this way, it is possible to improve the accuracy of detecting the pedestrian H.

In addition, in the embodiment described above, the case is described, where the camera 5 captures an image in front of the host vehicle. However, a case of calculating a distance to the pedestrian H projected on the captured image F input from the camera 5 that captures the side direction or the rear direction of the host vehicle, can be adopted.

In addition, the case is described, where the obstacle detection device 1 is mounted on the host vehicle, but the invention is not limited thereto. That is, the obstacle detection device 1 can detect the pedestrian H from the captured image F input from a fixed camera provided on a street lamp, a building or the like.

Further effects and modification examples can be easily derived by those skilled in the art. Therefore, the wider ranges of aspects of the present invention are not limited to the specific details and representative embodiments presented and described above. Accordingly, various changes may be made without departing from the spirit or scope of the general inventive concept as defined by the appended aspects and the equivalents thereof.

While the invention has been shown and described in detail, the foregoing description is in all aspects illustrative and not restrictive. It is therefore understood that numerous other modifications and variations can be devised without departing from the scope of the invention.

What is claimed is

1. An obstacle detection device that detects an obstacle, the obstacle detection device comprising a controller having a processor and memory, the controller configured to operate as:
a detector that detects a person region indicating a shape of a person from a captured image;
a generator that generates an optical flow based on (i) a non-detection image from which the person region is not detected and (ii) a detection image from which the person region was detected before a time of the non-detection image in a case where the person region currently is not detected in the captured image by the detector; and
an estimator that estimates the person region in the non-detection image based on the optical flow generated by the generator.

2. The obstacle detection device according to claim 1,
wherein the generator sets the person region in the detection image as a target region for generating the optical flow.

3. The obstacle detection device according to claim 1,
wherein the estimator estimates a distance and a direction to the person region by projecting coordinates of a lower end of the person region in the detection image to a coordinate plane.

4. The obstacle detection device according to claim 1,
wherein the estimator creates a histogram relating to a movement distance and a movement direction of a feature point in the detection image based on the optical flow generated by the generator, and estimates the movement distance and the movement direction of the person region based on a representative value in the histogram

5. The obstacle detection device according to claim 4,
wherein the estimator enlarges a scale of the person region in a case where it is estimated that the person is approaching a camera that obtains the captured image and reduces the scale of the person region in a case where it is estimated that the person is moving away from the camera based on the representative value.

6. The obstacle detection device according to claim 1,
wherein the estimator limits a number of times to continuously estimate the person region corresponding to a same person.

7. An obstacle detection method comprising the steps of:
(a) detecting, with a controller having a processor and memory, a person region where a shape of a person is present from a captured image;
(b) generating, with the controller, an optical flow based on (i) a non-detection image from which the person region is not detected and (ii) a detection image from Which the person region was detected before a time of the non-detection image, in a case where the person region currently is not detected in the captured image; and
(c) estimating, with the controller, the person region in the non-detection image based on the optical flow generated in the step (b).

8. The obstacle detection method according to claim 7,
wherein, in the step (b), the person region in the detection image is set as a target region for generating the optical flow.

9. The obstacle detection method according to claim 7,
wherein, in the step (c), a distance and a direction to the person region are estimated by projecting coordinates of a lower end of the person region in the detection image to a coordinate plane.

10. The obstacle detection method according to claim 7,
wherein, in the step (c), a histogram relating to a movement distance and a movement direction of a feature point in the detection image is created based on the optical flow generated in the step (b), and the movement distance and the movement direction of the person region are estimated based on a representative value in the histogram.

11. The obstacle detection method according to claim 10,
wherein, in the step (c), a scale of the person region is enlarged in a case where it is estimated that the person is approaching a camera that obtains the captured image and the scale of the person region is reduced in a case where it is estimated that the person is moving away from the camera, based on the representative value.

12. The obstacle detection method according to claim 7,
wherein, in the step (c), a number of times to continuously estimate the person region corresponding to a same person is limited.

13. A non-transitory computer-readable recording medium that stores a program to be executed by a computer having a processor and memory, the program causing the computer to execute the steps of:
(a) detecting a person region where a shape of a person is present from a captured image;
(b) generating an optical flow based on (i) a non-detection image from which the person region is not detected and (ii) a detection image from which the person region was detected before a time of the non-detection image, in a case where the person region currently is not detected in the captured image; and
(c) estimating the person region in the non-detection image based on the optical flow generated in the step (b).

14. The non-transitory computer-readable recording medium according to claim 13,
wherein, in the step (b), the person region in the detection image is set as a target region for generating the optical flow.

15. The non-transitory computer-readable recording medium according to claim 13,
wherein, in the step (c), a distance and a direction to the person region are estimated by projecting coordinates of a lower end of the person region in the detection image to a coordinate plane.

16. The non-transitory computer-readable recording medium according to claim 13,
wherein, in the step (c), a histogram relating to a movement distance and a movement direction of a feature point in the detection image is created based on the optical flow generated in the step (b); and the movement distance and the movement direction of the person region are estimated based on a representative value in the histogram.

17. The non-transitory computer-readable recording medium according to claim 16,
wherein, in the step (c), a scale of the person region is enlarged in a case where it is estimated that the person is approaching a camera that obtains the captured image and the scale of the person region is reduced in a case where it is estimated that the person is moving away from the camera based on the representative value.

18. The non-transitory computer-readable recording medium according to claim 13,
wherein, in the step (c), a number of times to continuously estimate the person region corresponding to a same person is limited.
